(19) United States
(12) Patent Application Publication
(10) Pub. No.: US 2003/0188206 A1
(43) Pub. Date: Oct. 2, 2003

(54) Electric apparatus, computer, intelligent battery and AC adapter checking method

(75) Inventor: Shigefumi Odaohhara, Yamato-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/402,529

(22) Filed: Mar. 28, 2003

(30) Foreign Application Priority Data
Mar. 29, 2002 (JP) 2002-097546

(51) Int. Cl. G06F 1/26

(52) U.S. Cl. 713/300

(57) ABSTRACT

A system main body, which is constructed to be able to be equipped with an AC adapter for converting alternative current to direct current and receives power supply from the AC adapter, and an intelligent battery, which is charged by receiving electric power from the AC adapter and supplies electric power to the main body by discharge. A CPU within the intelligent battery outputs to an embedded controller disposed to the system main body information indicating that the AC adapter is not regular when charging current supplied by the AC adapter and measured by a current measurement circuit becomes a level lower than a predetermined value indicating completion of charge and when voltage of a cell measured by a voltage measurement circuit and calculated accumulated capacity doesn't reach each specified value allowing to be judged that sufficient charge level is obtained.

### FIELD AND BACKGROUND OF THE INVENTION

The present invention relates to an electric apparatus such as a notebook PC (notebook type personal computer), and more particularly to an electric apparatus being connectable to an AC adapter.

Various electric apparatuses such as an information processing apparatus, typically the notebook PC, are usually supplied with electric power from an AC adapter as a power supply device in addition to an internal battery. This AC adapter converts an AC (Alternating Current) input voltage supplied when plugged in a household power receptacle into a DC (Direct Current) output voltage and supplies electric power to a main body of the apparatus via a specific cable. This AC adapter is widely used for not only the notebook PCs but also the peripheral devices such as an external hard disk, CD-R/RW drive, a modem, and TA, as well as telephone sets, home facsimile, and various audio apparatuses such as MD.

In recent years, for instance, the notebook PC as an information terminal apparatus is enhanced in performance as an operating frequency of CPU becomes higher for every release of a new model. At the same time, the maximum power consumption of the notebook PC tends to increase year after year from 35W to 56W to 72W, for example. On the other hand, since the plug of the AC adapter is mostly 2-pin normal barrel type, some users who have bought a new model notebook PC that uses an AC adapter of large capacity (e.g., capacity of 72W) continue to use an AC adapter of small capacity (e.g., capacity of 56W) employed for the old model notebook PC.

Accompanying FIG. 7 is a graph showing a relation between power consumption of a system and charging power of a battery in a notebook PC. The axis of abscissa represents the time, and the axis of ordinate represents the power (watt). Assuming that the capacity of old AC adapter (having smaller capacity) is 56W, the capacity of new AC adapter (having larger capacity) is 72W, and the power consumption of the system is varied as shown in FIG. 7. Here, in the notebook PC, for example, a secondary battery is used for supplying power to the system by discharge after charge, and a so-called operational charging is widely used in which the secondary battery is charged while the notebook PC is being operated. As shown in FIG. 7, the capacity of AC adapter is constant, and the capacity of AC adapter subtracted by the power consumption of system is allocated to the charging power of the secondary battery. For example, at point A in FIG. 7, a difference between 72W of the capacity of new AC adapter and the power consumption of system and a difference between 56W of the capacity of old AC adapter and the power consumption of system are indicated by the values of <1> and <2> in FIG. 7, respectively, in which the powers having the values of <1> and <2> are employed for charging the secondary battery that supplies power to the system by discharge after charge.

Here, a lithium ion battery as the secondary battery, for instance, generally employs a method for judging full of charge depending on whether or not the charging current is the specified value or less. In a case where the user connects by mistake the old AC adapter of 56W to the notebook PC though the user must connect the new AC adapter of 72W properly, the charging power (i.e., charging current) becomes very small in an area B of FIG. 7. For example, at point of time <3> as shown in FIG. 7, the charging current is lower than a threshold current (e.g., 150 mA) owing to a difference between the capacity 56W of old AC adapter and the power consumption of system, and the charging current is continually lower than the threshold current in the area B following the point <3> beyond the judgement time (e.g., one minute). Under such conditions, the lithium ion battery is judged to be full of charge even if the real capacity is below 100%, in which the charging is stopped by setting the capacity data to 100%. That is, the lithium ion battery is misjudged to be full of charge when it is not, whereby the real capacity may be less than 100% even if the capacity data indicates 100%. If the system in this state is driven from the battery, the real capacity becomes 0% before the capacity data becomes 0%, halting system operation, thereby the user misconceives that the drive time of battery is short and the battery is defective. As a result, in some cases, the normal battery was replaced as defective.

Also, when a nickel hydrogen battery is employed as the secondary battery, the life of battery may be reduced due to lower charging current, if the AC adapter of smaller capacity is employed by mistake. That is, the nickel hydrogen battery can not be judged to be full of charge and may be overcharged when the charging current is small. If this charging is repeated, the nickel hydrogen battery may be damaged many times to shorten the life of battery.

On the other hand, in Published Unexamined Patent Application No. 2001-224131, a technique was disclosed in which the AC adapter is internally provided with a voltage/capacity data storing portion, and communicated with the system main unit to recognize the properties of the AC adapter. However, to cope with the above-mentioned problem, it is required that all the AC adapters have the above constitution, and the AC adapters not having the above constitution can not cope with the problem. Furthermore, the capacity data storing portion, the communication cable, and the plug for connection with the system main unit are very expensive, resulting in a problem that the cost of the electric apparatus is increased.

The present invention has been achieved in the light of the above-mentioned technical problems, and it is one purpose of the invention to easily detect that a false AC adapter is connected to the system main unit.

### SUMMARY OF THE INVENTION

In order to accomplish the-above object, this invention makes it possible to detect a false AC adapter connected on the basis of the charge status of connected battery being charged from the AC adapter, even when the AC adapter has no identification information or the like. That is, this invention provides an electric apparatus comprising a main body being able to be connected to an AC adapter for converting alternative current to direct current and being supplied power from the AC adapter, the electric apparatus being possible to be equipped with a battery for supplying power to the main body by discharge after charge by power from the AC adapter, the electric apparatus comprising a charge status monitor means for monitoring a charge status to the connected battery from the connected AC adapter, an adaptability judgement means for judging whether or not the AC adapter has adaptability in response to a charging status of the battery monitored by the charge status monitor means, and display means for displaying a warning when the adaptability judgement means judges that the AC adapter is unmatched with the main body.

Here, the charge status monitor means monitors whether or not charging current becomes a level lower than a predetermined value indicating completion of charge and whether or not voltage of a battery cell and/or accumulated capacity reaches each specified value allowing to be judged that sufficient charge level is obtained. Thus, it is preferably possible to judge whether or not the connected AC adapter has adaptability on the basis of the charging status to a lithium ion battery connected, for example.

Also, the charge status monitor means monitors whether or not a temperature rise per unit time exceeds a rate which is regarded as full charge of the battery and whether or not the temperature rise is lower than an average charging current necessary to obtain an accurate temperature rise. Thus, it is advantageously possible to judge whether or not the connected AC adapter has adaptability on the basis of the charging status to a nickel hydrogen battery connected, for example.

Also, this invention provides an electric apparatus comprising a main body being able to be connected to an AC adapter for converting alternative current to direct current and being supplied power from the AC adapter, and a battery being charged by power from the AC adapter and supplying power to the main body by discharge, wherein the battery outputs to the main body the information that the AC adapter does not have adaptability when charging current supplied from the AC adapter becomes a level lower than a predetermined value indicating completion of charge, and voltage of a battery cell and/or accumulated capacity reaches each specified value allowing to be judged that sufficient charge level is obtained. It is possible to judge whether or not the battery cell or accumulated capacity reaches each specified value, but preferable to judge whether or not both the battery cell and accumulated capacity reach their specified values to assure more accurate status.

Here, the battery updates the “full charge capacity (FCC) of battery at present” with the total or almost total amount of discharge, when the normal AC adapter is connected. However, when the AC adapter does not adaptability, the total discharge amount is not correctly monitored, whereby it is preferred not to update the full charge capacity of battery with the total amount of discharge.

In another view point, an electric apparatus according to the invention comprising a main body and a battery, wherein the battery outputs to the main body the information that the AC adapter does not have adaptability when a temperature rise per unit time exceeds a rate which is regarded as full charge of the battery and the temperature rise is lower than an average charging current necessary to obtain an accurate temperature rise. Also, the main body stops charging the battery to protect it, when the information indicating that the AC adapter does not have adaptability is output from the battery.

Moreover, this invention provides a computer comprising a system being able to be connected to an AC adapter for converting alternative current to direct current and being supplied power from the AC adapter, the computer being possible to be equipped with a battery for supplying power to the system by discharge after charge by power from the AC adapter, the computer comprising a charge status monitor means for monitoring a charge status to the battery from the connected AC adapter, and an adaptability judgement means for judging whether or not the AC adapter has adaptability in response to a charging status of the battery monitored by the charge status monitor means.

In another view point, this invention provides a computer comprising a first judgement means for judging whether or not charging current supplied from the AC adapter to the battery becomes a level lower than a predetermined value indicating completion of charge, a second judgement means for judging whether or not voltage of a battery cell and/or accumulated capacity of the battery reaches each specified value allowing to be judged that sufficient charge level is obtained, and an adaptability judgement means for judging whether or not the AC adapter connected to the system has adaptability in response to a judgement of the first judgement means and a judgement of the second judgement means.

Here, the adaptability judgement means judges that the AC adapter connected to the system has no adaptability to the system when the first judgement means judges that charging current becomes a level lower than a predetermined value (e.g., 150 mA) and the second judgement means judges that voltage of the battery cell and/or the accumulated capacity does not reach each specified value (e.g., voltage of 4.1V, residual capacity percent of 90%).

In another view point, this invention provides a computer comprising a system being able to be connected to an AC adapter for converting alternative current to direct current and being supplied power from the AC adapter, the computer being possible to be equipped with a battery for supplying power to the system by discharge after charge by power from the AC adapter, the computer comprising temperature rise monitor means for monitoring whether or not a temperature rise per unit time exceeds a rate which is regarded as full charge of the battery, charging current monitor means for monitoring whether or not an average charging current is lower than a reference value necessary to cause a normal temperature rise, and an adaptability judgement means for judging that the AC adapter does not have adaptability when the temperature rise monitored by the temperature rise monitor means exceeds the rate and the average charging current monitored by the charging current monitor means is lower than the reference value.

Also, this invention provides an intelligent battery being able to be connected to an electric apparatus and supplying power to a main body of the electric apparatus by discharge after charge by power from an AC adapter connected to the electric apparatus. This intelligent battery comprises a charging current monitor means for monitoring a charging current supplied from the AC adapter, a voltage/capacity monitor means for monitoring voltage of a cell making up the intelligent battery and/or accumulated capacity of the battery, and an adaptability judgement means for judging whether or not the AC adapter connected to the main body has adaptability in response to a monitor of the charging current by the charging current monitor means and a monitor of the voltage of the cell and/or accumulated capacity by the voltage/capacity monitor means.

Here, the charging current monitor means monitors whether or not charging current becomes a level lower than a predetermined value indicating completion of charge, the voltage/capacity monitor means monitors whether or not the voltage of the cell and/or the accumulated capacity reaches each specified value allowing to be judged that sufficient charge level is obtained, and the adaptability judgement means judges that the AC adapter connected to the main body does not have adaptability when the charging current monitor means monitors that the charging current is lower than the predetermined value and the voltage/capacity monitor means monitors that the voltage and/or the accumulated capacity does not reach each specified value.

Also, this invention provides an intelligent battery comprising a temperature rise monitor means for monitoring a level of temperature rise, a charging current monitor means for monitoring a level of charging current supplied from the AC adapter, and an adaptability judgement means for judging whether or not the AC adapter connected to the main body has adaptability in response to the level of the temperature rise monitored by the temperature rise monitor means and the level of the charging current monitored by the charging current monitor means.

Here, the temperature rise monitor means monitors whether or not a temperature rise per unit time exceeds a rate which is regarded as full charge, the charging current monitor means monitors whether or not an average charging current is lower than a reference value necessary to cause a normal temperature rise, and the adaptability judgement means judges that the AC adapter does not have adaptability when the temperature rise exceeds the rate and the average charging current is lower than the reference value.

Further, this invention provides a method for checking an AC adapter connected to an electric apparatus, comprising a first step of judging whether or not charging current supplied from the AC adapter to the battery for supplying power by discharge after charge becomes a level lower than a predetermined value indicating completion of charge, a second step of judging whether or not voltage of a battery cell and/or accumulated capacity of the battery reaches each level allowing to be judged that sufficient charge level is obtained by charge from the AC adapter, and a third step of judging whether or not the connected AC adapter has adaptability in response to the judgements of the first and second steps.

Moreover, this invention provides a method for checking an AC adapter, comprising a first step of judging whether or not a temperature rise per unit time exceeds a rate which is regarded as full of charge for a battery for supplying power by discharge after charge, a second step of judging whether or not an average charging current is lower than a reference value necessary to cause a normal temperature rise by charge from the AC adapter, and a third step of judging that the connected AC adapter does not have adaptability when the temperature rise monitored at the first step exceeds the rate and the average charging current monitored at the second step is lower than the reference value.

### BRIEF DESCRIPTION OF THE DRAWINGS

Some of the purposes of the invention having been stated, others will appear as the description proceeds, when taken in connection with the accompanying drawings, in which:

FIG. 1 is a block diagram showing the hardware configuration of a computer system that is an electric apparatus according to an embodiment of the present invention;

FIG. 2 is a circuit diagram showing a circuit configuration of this embodiment;

FIG. 3A is a graph showing the characteristic of a battery charger when a lithium ion battery is employed as an intelligent battery, and FIG. 3B is a graph showing the charging characteristics of the lithium ion battery;

FIG. 4 is a flowchart showing a process that is performed by the CPU inside the intelligent battery;

FIG. 5 is a view showing a message example displayed to the user;

FIG. 6 is a flowchart showing a process that is performed by the CPU inside the intelligent battery when a nickel hydrogen battery is employed; and

FIG. 7 is a graph showing the relation between power consumption of system and-charging power of battery in the notebook PC.

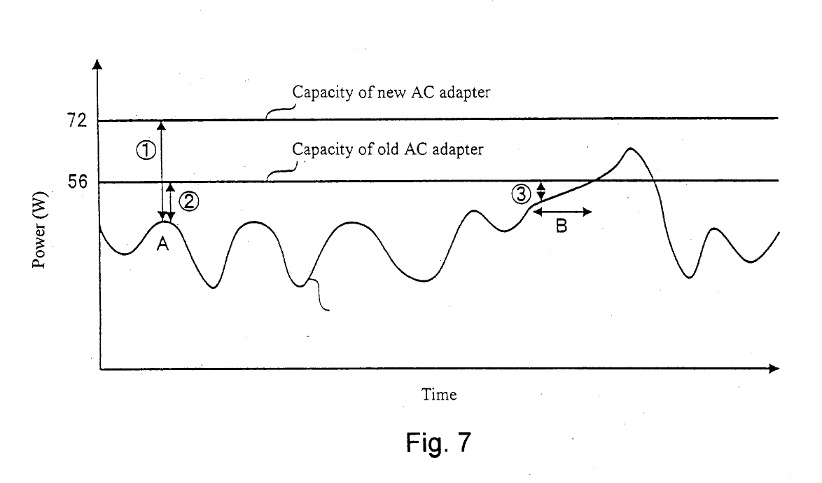

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

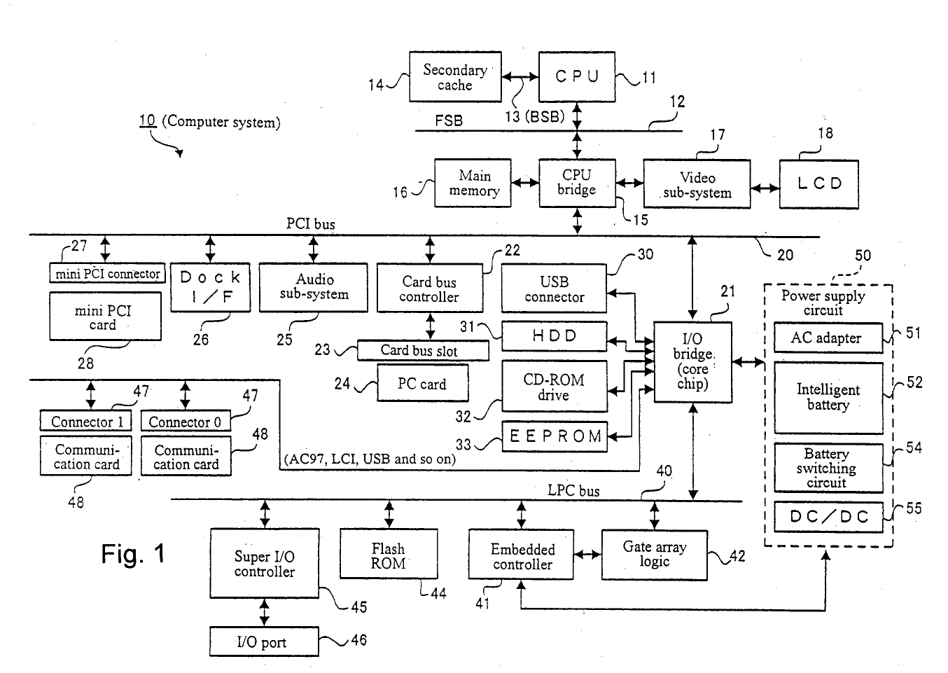

Referring now to FIG. 1, a block diagram there shows the hardware configuration of a computer system 10 that is an electric apparatus according to an embodiment of the invention. A computer having this computer system 10 (hereinafter simply referred to as a “system”) is configured as a notebook type personal computer (notebook PC) with an OS mounted, conforming to the OADG (Open Architecture Developer's Group) specification, for example.

In the computer system 10 as shown in FIG. 1, a CPU 11 operates as a brain of the computer system 10 as a whole, and executes various programs including the utility programs under the control of the OS. The CPU 11 is interconnected to each component via the buses at three stages, including an FSB (Front Side Bus) 12 that is a system bus, a PCI (Peripheral Component Interconnect) bus 20 as a fast I/O device bus, and an LPC (Low Pin Count) bus 40 as an I/O device bus. This CPU 11 has a program code and the data in a cache memory to make the fast processing. In recent years, an SRAM of about 128K bytes as a primary cache is accumulated inside the CPU 11, but to supplement a shortage of the capacity, a secondary cache 14 of about 512K to 2M bytes is disposed via a BSB (Back Side Bus) 13 that is a dedicated bus. It is also possible that the BSB 13 is omitted and the secondary cache 14 is connected to the FSB 12 to avoid a package with more terminals, whereby the cost is reduced.

The CPU as herein used enables a mode control and can be operated in a normal mode or a low speed mode (Low Power Mode). As a method for decreasing the operation speed of the CPU 11, for example, there are Speed Step technique made by Intel, Inc. (decreasing the operating frequency and operation voltage of processor) and throttling technique (decreasing the operating frequency artificially by turning on/off the processor periodically). To operate the CPU 11 in the low speed mode, for example, the clock of the CPU 11 is reduced from normally 850 MHz to 750 MHz, and the voltage of the CPU 11 is decreased from normally 1.6V to about 1.35V.

The FBS 12 and the PCI bus 20 are communicated via a CPU bridge (host-PCI bridge) 15 called a memory/PCI chip. This CPU bridge 15 comprises a memory controller function of controlling the access operation to a main memory 16 and a data buffer for absorbing a difference in the data transfer rate between the FBS 12 and the PCI bus 20 or the like. The main memory 16 is a writable memory to be used as a read area for reading an execution program of the CPU 11 or a working area for writing the processed data of the execution program. For example, the main memory 16 is composed of a plurality of DRAM chips, with a normal capacity of, for example, 64 MB, and can be augmented up to 320 MB. Examples of this execution program include the OS, various kinds of drivers for operating the hardware of peripheral devices, the application programs directed for specific applications, and a firmware such as the BIOS (Basic Input/Output System) stored in a flash ROM 44.

A video sub-system 17 is a sub-system for implementing the functions related with the video, containing a video controller. This video controller processes a drawing instruction from the CPU 11 to write the drawing information into a video memory, and reads the drawing information from the video memory to output the drawing data to a liquid crystal display (LCD) 18.

The PCI bus 20 is the bus capable of making the data transfer at relatively high speed, and normalized with a specification in which the data bus width is 32 bits or 64 bits, the maximum operating frequency is 33 MHz or 66 MHz, and the maximum data transfer rate is 132 MB/sec or 528 MB/sec. To this PCI bus 20, an I/O bridge 21, a card bus controller 22, an audio sub-system 25, a docking station interface (Dock I/F) 26 and a mini PCI (miniPCI) connector 27 are each connected.

The card bus controller 22 is a dedicated controller for directly coupling a bus signal of the PCI bus 20 into an interface connector (card bus) of the card bus slot 23, into which the PC card 24 can be loaded. The docking station interface 26 is the hardware for connecting a docking station (not shown) that is a function expansion device of the computer system 10. If the notebook PC is set in the docking station, various kinds of hardware elements connected to an internal bus of the docking station are connected via the docking station interface 26 to the PCI bus 20. Also, a mini PCI card 28 is connected to the mini PCI connector 27.

The I/O bridge 21 has a bridge function between the PCI bus 20 and the LPC bus 40. Also, it has a DMA controller function, a programmable interrupt controller (PCI) function, a programmable interval timer (PIT) function, an IDE (Integrated Device Electronics) interface function, a USB (Universal Serial Bus) function, an SMB (System Management Bus) interface function, and contains a real time clock (RTC).

The DMA controller function enables the data transfer to be made between the peripheral device such as FDD and the main memory 16 without interposition of the CPU 11. The PIC function enables a predetermined program (interrupt handler) to be executed in response to an interrupt request (IRQ) from the peripheral device. The PIT function enables a timer signal to be generated at a certain period. Also, to the interface implemented by the IDE interface function, an IDE hard disk drive (HDD) 31 is connected, and a CD-ROM drive 32 is connected in ATAPI (AT Attachment Packet Interface). Instead of this CD-ROM drive 32, other type of IDE device such as a DVD (Digital Versatile Disc) drive may be connected. The external storage devices such as HDD 31 and CD-ROM drive 32 are stored in a storage location called a “media bay” or “device bay” within the notebook PC main body. The external storage device mounted as standard may be exchanged by other devices such as FDD or a battery pack exclusively.

A USB port is provided in the I/O bridge 21, and connected with a USB connector 30 provided, for example, on a wall surface of the notebook PC main body. Moreover, the I/O bridge 21 has an EEPROM 33 connected via an SM bus. This EEPROM 33 is a memory for holding a password registered by the user, a supervisor password, and the product serial number, and non-volatile and electrically rewritable. A plurality of connectors 47 are connected to the I/O bridge 21 via AC 97 (Audio CODEC' 97) that supports the modem function, LCI (LAN Connect Interface) as the interface to the Ethernet [symbol] contained in a core chip and USB or the like. A communication card 48 can be connected to each of the plurality of connectors 47.

Moreover, the I/O bridge 21 is connected to a power supply circuit 50. This power supply circuit 50 comprises an AC adapter 51 for making the AC/DC conversion by being connected to a commercial power supply of AC 100V, an intelligent battery 52 as a secondary battery composed of a nickel hydrogen battery, a nickel cadmium battery, a lithium ion battery or a lithium polymer battery used by repeating the charge and discharge, a battery switching circuit 54 for switching between the AC power supply from the AC adapter 51 and the battery power from the intelligent battery 52, and a DC/DC converter (DC/DC) 55 for generating a DC constant voltage such as +15V, +5V or +3.3V that is used in the computer system 10. The intelligent battery 52 internally comprises a CPU, and communicates with an embedded controller 41 (described below) in conformance, for example, to SBS (Smart Battery System).

On the other hand, an internal register for managing the power state of the computer system 10 and a logic (state machine) for managing the power state of the computer system 10 involving the operation of the internal register are provided inside a core chip constituting the I/O bridge 21. This logic sends and receives various kinds of signal to and from the power supply circuit 50, and recognizes an actual feed state from the power supply circuit 50 to the computer system 10 by sending and receiving the signal. The power supply circuit 50 controls the power supply to the computer system 10 in response to an instruction from this logic.

The LPC bus 40 is conformable to the interface standard for connecting a legacy device to the system having no ISA bus, in which the command, address and data are passed through the same four signal lines (LAD signal) at an operation clock of 33 MHz (e.g., 8 bit of data is transferred at 4bit┤2 clock). To this LPC bus 40, the embedded controller 41, a gate array logic 42, a flash ROM 44, and a Super I/O controller 45 are connected. Moreover, the LPC bus 40 is also employed to connect the peripheral devices operating at relatively low rate such as a keyboard and a mouse controller. An I/O port 46 is connected to the Super I/O controller 45 for controlling the driving of FDD, the parallel data input and output (PIO) via a parallel port, and the serial data input and output (SIO) via a serial port.

The embedded controller 41 controls the keyboard, not shown, and is connected to the power supply circuit 50 to cover a part of the power management function under the control of a built-in PMC (Power Management Controller) along with the gate array logic 42.

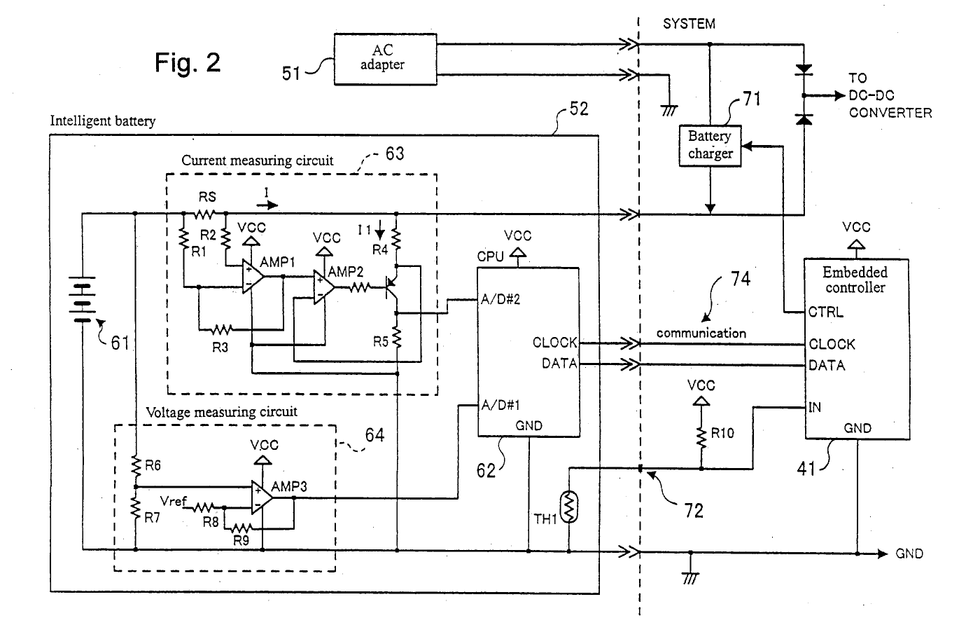

FIG. 2 is a circuit diagram showing a circuit configuration of this embodiment. In the circuit configuration as shown in FIG. 2, the AC adapter 51 that is a power supply device connected to the commercial power supply and the intelligent battery 52 composed of a lithium ion battery and conforming to the SBS (Smart Battery System) are shown on the power supply side. Also, the embedded controller 41 for making communication via a communication line 74 with the intelligent battery 52, a battery charger 71 for charging the intelligent battery 52, and a battery connection check terminal 72 for checking whether or not the intelligent battery 52 is connected are shown on the main unit system side. Power supplied from the AC adapter 51 and the intelligent battery 52 is output via the DC/DC converter 55 as shown in FIG. 1 to the system main unit of the computer system 10.

The internal configuration of the intelligent battery 52 that is a battery pack will be described below. As shown in FIG. 2, the intelligent battery 52 comprises a cell 61 composed of a plurality of unit cells to be charged and discharged, a CPU 62 for controlling the intelligent battery 52 and making communication via the embedded controller 41 and the communication line 74, a current measuring circuit 63 for measuring the current value discharged from the intelligent battery 52, and a voltage measuring circuit 64 for measuring the voltage of the cell 61. The cell 61 is a lithium ion combination battery composed of six cells, two in parallel and three in series (1.8 Ah/cell), for example. The CPU 62 mounted inside this intelligent battery 52 internally converts an analog signal of measurement result entered from the current measuring circuit 63 or the voltage measuring circuit 64 into digital form (Analog to Digital conversion) to acquire the battery data such as capacity of battery. The acquired battery data is transmitted via the communication line 74 as the transmission path to the embedded controller 41 on the system side in accordance, for example, with the SBS protocol.

A thermistor (not shown) in which voltage is divided by the register is disposed in the vicinity of the cell 61, in which a voltage generated in the thermistor is passed to the port of the CPU 62. In this manner, the voltage from the thermistor is read and converted from analog to digital form by the CPU 62, to measure the temperature. Thereby, the intelligent battery 52 can monitor the temperature inside the battery.

In the current measuring circuit 63, first of all, a potential difference as large as voltage l┤RS is generated across a resistor (RS) owing to a current l flowing from the cell 61. This voltage is differentially amplified by an operational amplifier (AMP1). Also, an operational amplifier (AMP2) and a transistor enable a current l1 proportional to the output voltage of the operational amplifier (AMP1) to flow through a resistor (R4). Finally, the value of the current l of the intelligent battery 52 can be converted into the voltage l1┤R5 generated in the resistor (R5). This voltage l1┤R5 is output to A/D#2 port of the CPU 62, and converted from analog to digital form by the CPU 62. Also, in the voltage measuring circuit 64, the voltage of the cell 61 in the intelligent battery 52 is differentially amplified by an operational amplifier (AMP3), once dropped to a lower voltage, passed to A/D#1 port of the CPU 62, and converted from analog to digital form by the CPU 62. The residual capacity of battery is managed by the CPU 62 inside the battery pack, on the basis of the current value measured by the current measuring circuit 63 and the voltage value measured by the voltage measuring circuit 64.

Various kinds of information of the intelligent battery 52 monitored by those circuits are sent to the embedded controller 41 on the system side in accordance with the protocol conforming to the SBS. In an instance of the SBS, a data signal (DATA) and a clock signal (CLOCK) are employed to make the communications. When there is a request for ChargingCurrent ( ) and ChargingVoltage ( ) with the commands 0┤14 and 0┤15 from the system side to the intelligent battery 52, the intelligent battery 52 receiving this request returns ChargingCurrent ( ) and ChargingVoltage ( ) larger than zero (e.g., ChargingCurrent ( )=2600 mA, ChargingVoltage ( )=12.6V) to the embedded controller 41 to charge the battery when the capacity is lower than a certain value (e.g., 95%) and the conditions such as temperature are matched. Receiving ChargingCurrent ( ) and ChargingVoltage ( ) larger than zero, the embedded controller 41 controls a CTRL signal to turn on the battery charger 71.

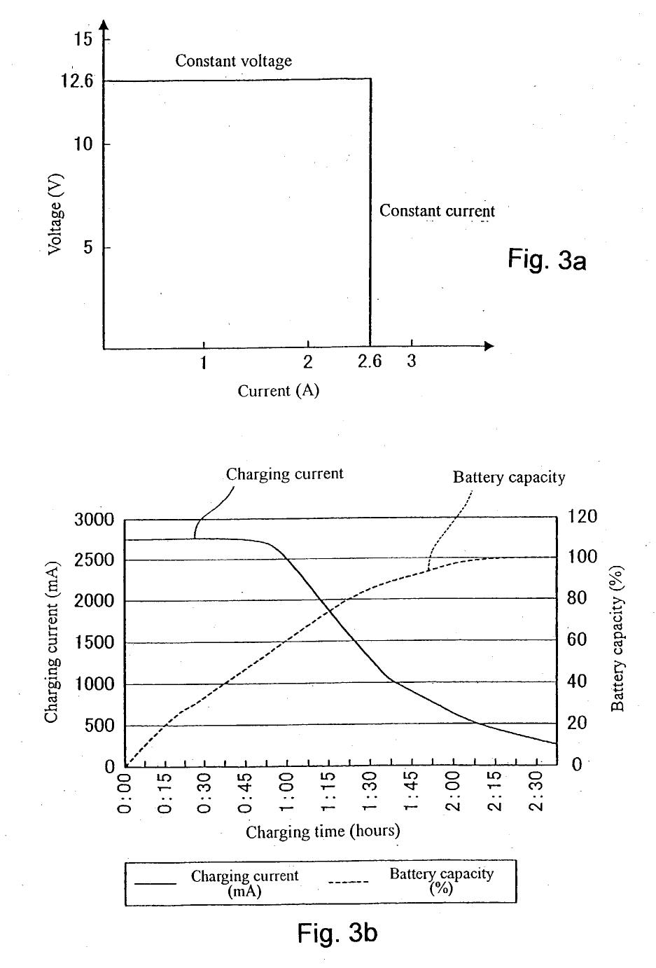

FIG. 3A is a graph showing the characteristic of the battery charger when a lithium ion battery is employed as the intelligent battery 52, in which the axis of abscissa represents the current (A) and the axis of ordinate represents the voltage (V). As shown in FIG. 3A, when the lithium ion battery is employed, the battery charger 71 has a constant voltage and constant current characteristic. Also, FIG. 3B is a graph showing the charging characteristics of the lithium ion battery, in which the charging current (mA) and the battery capacity (%) are represented with respect to the charging time (hours). As shown in FIG. 3B, the battery is charged with a constant current (constant current characteristic of the battery charger 71) till the battery capacity reaches about 60% (about one hour after starting charging). Then, the battery charger 71 has a constant voltage characteristic, with the charging current gradually smaller as shown in FIG. 3B. If the charging current is smaller than a certain value (e.g., 150 mA), or lower than a predetermined value indicating completion of charging, it is regarded that charging the intelligent battery 52 has been completed. At this time, the CPU 62 inside the intelligent battery 52 sets the residual capacity data at 100% (RemainingCapacity ( )=FullChargeCapacity ( )). In this state, the embedded controller 41 makes a request for ChargingCurrent ( ) and ChargingVoltage ( ), the intelligent battery 52 returns zero to at least one value (0 mA or 0V). Thereby, the embedded controller 41 recognizes that the charging is completed and turns off the battery charger 71.

Herein, consider an instance where the AC adapter 51 of 72W is essentially employed but the AC adapter 51 of 56W is employed by mistake. In this instance, the charging current is smaller when the power consumption of the system main unit is greater, and if this charging current is lower than a certain value, the intelligent battery 52 falsely recognizes that the charging is completed. To avoid this problem, the CPU 62 inside the intelligent battery 52 recognizes that the AC adapter 51 is falsely connected when the OCV (Open Circuit Voltage) and/or accumulated capacity at the time of detecting full of charge is lower than or equal to each specified value. The embedded controller 41 acquires a series of battery data in accordance with the SBS protocol periodically (e.g., every two seconds).

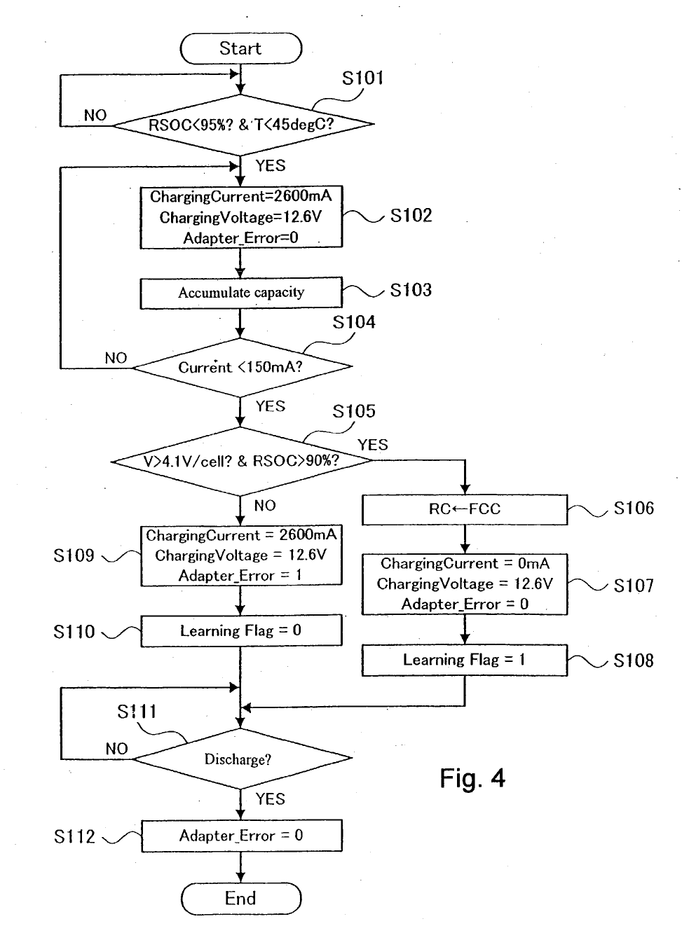

FIG. 4 is a flowchart showing a process that is performed by the CPU 62 inside the intelligent battery 52. First of all, the CPU 62 makes a judgement of whether or not the residual capacity percentage RSOC (Relative State Of Charge) of the battery (cell 61) is smaller than 95%, and the battery temperature T (Temperature) is lower than 45 [symbol] C. (step 101). If this condition is not satisfied, the battery can not be charged, whereby the operation returns to step 101. If this condition is satisfied, the battery can be charged, whereby the operation transfers to step 102.

If the condition at step 101 is satisfied, ChargingCurrent ( )=2600 mA and ChargingVoltage ( )=12.6V are sent to the embedded controller 41 (step 102). The embedded controller 41 receiving the data controls the CTRL terminal to turn on the battery charger 71. When a command code 0×3 f (OptionalMfgFunctionl) of the SBS is a read word, it is indicated at bit 15 (Adapter_Error) of the data whether or not the AC adapter 51 is normal. When the false AC adapter 51 is connected, Adapter_Error is defined as 1, while when the normal AC adapter 51 is connected, Adapter_Error is defined as 0. Accordingly, Adapter_Error is zero at default setting.

Since the system side starts charging at step 102, the capacity is accumulated inside the intelligent battery 52 (step 103), and the residual amount data RC (Remaining Capacity) is updated. The battery capacity is managed by current accumulation (AH) or power accumulation (WH). When managed in a unit of AH, the battery capacity is fundamentally managed only by the current value measured by the current measuring circuit 63. On the other hand, when managed in a unit of WH, the battery capacity is managed not only by the current value measured by the current measuring circuit 63 but also the battery voltage value measured by the voltage measuring circuit 64. The current value measured by the current measuring circuit 63 is the discharge current from the intelligent battery 52 (cell 61) and the charging current.

Then, the CPU 62 judges whether or not the charging current (Current) is smaller than 150 mA (step 104). If not smaller, the operation returns to step 102 to continue charging. If smaller, the operation proceeds to step 105. Herein, it is checked whether or not the battery voltage is higher than the specified value to be judged that sufficient charging amount is obtained, or 4.1V per cell, and the RSOC is greater than 90% (step 105). If this condition is satisfied, sufficient charging amount is supplied to the cell 61, whereby the AC adapter 51 is regarded as normal. Then, the operation proceeds to step 106. If the condition is not satisfied, the false AC adapter 51 is regarded as being connected, in which the operation goes to step 109. When the battery voltage is measured, a relatively accurate voltage value can be read even during the charging because the charging current is smaller than 150 mA. However, if the battery voltage is read by temporarily stopping the charging, employing a charge stop FET (not shown) provided as a protective circuit for the typical lithium ion battery, the more accurate voltage value can be obtained.

If the AC adapter 51 is regarded as normal at step 105, the charging is normally completed, whereby the value of FCC (Full Charge Capacity) is substituted for the remaining amount data (RC) (step 106). Herein, FCC is the total amount of battery (cell 61) at present. Then, ChargingCurrent=0 mA and ChargingVoltage=12.6V are sent to the embedded controller 41 to stop the charging. Since the AC adapter 51 is normal, data is sent after bit 15 (Adapter_Error) of the word data set to 0, if command code 03×f is received from the embedded controller 41 (step 107). Also, since the charging is normally ended, the CPU 62 of the embedded controller 41 set an internal flag (Learning Flag) to 1 (step 108). If this flag is on, the full charge capacity of battery (FCC) is updated with the total discharge amount of battery that is actually discharged, when the embedded controller 41 undergoes full discharge (or almost full discharge, e.g., up to capacity 3%).

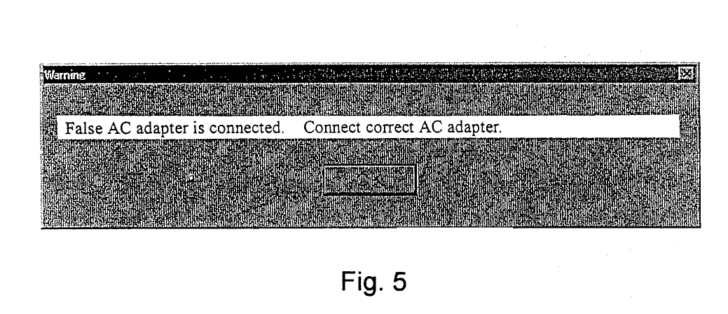

When the AC adapter 51 is regarded as abnormal at step 105, the CPU 62 continues to issue a charging request (ChargingCurrent=2600 mA, ChargingVolatge=12.6V). Since the AC adapter 51 is regarded as abnormal, Adapter_Error is set at 1 and data is sent to the embedded controller 41 (step 109). If the embedded controller 41 detects that 1 is set at bit 15 (Adapter_Error) of the received word data, it notifies a utility program of battery that the AC adapter 51 is abnormal. This utility program displays a message as shown in FIG. 5 on the LCD 18 for the user to make sure whether or not the AC adapter 51 is normal. Since the charging is abnormally ended, the internal learning flag (Learning Flag) is set to 0 (step 110). If this flag is zero, the full charge capacity of battery (FCC) is not updated with the total discharge amount even when the battery is fully discharged (or almost fully discharged).

After step 110, a check is made whether the battery is being discharged (step 111). If not, the check is continued, and if the discharging is detected, it is meant that the abnormal AC adapter 51 is removed from the system main unit, whereby Adapter_Error is set to 0 (step 112) and the operation is ended.

In this embodiment, when the lithium ion battery is employed as the intelligent battery 52, the OCV (Open Circuit Voltage) and/or the accumulated capacity in detecting full of charge are checked inside the battery pack of the intelligent battery 52. If the OCV and/or the accumulated capacity is lower than each specified value, recognizing that the false AC adapter 51 is connected, the information is notified to the embedded controller 41 using the communication function. Herein, “and/or” is used to assure the recognition by detecting at least one, and to increase the accuracy of recognition by-detecting both. The embedded controller 41 sends the information to the utility program to display a message that the false AC adapter 51 is connected (see FIG. 5), whereby the user is guided to connect the normal AC adapter 51. Thus, it is possible to avoid misrecognition that the battery is full of charge because of different AC adapter 51 connected.

An instance where the nickel hydrogen battery is used as the intelligent battery 52 will be described below. In the instance of the nickel hydrogen battery, it is common to detect full of charge with Dt/DT (temperature rise per unit time). The CPU 62 senses the temperature of the cell 61 using a thermistor (not shown), and regards the battery as full of charge if the cell 61 has a temperature rise of 1.5 [symbol] C. for one minute, for example. In this battery, a problem is that when the AC battery 51 having small capacity may be accidentally connected, the cell 61 has less temperature rise due to a small charging current, though the capacity reaches 100%. In this state, the intelligent battery 52 is overcharged, and the cell 61 is damaged, resulting in worse operation characteristics. Also, it is theoretically necessary to take notice of the occurrence of liquid leakage.

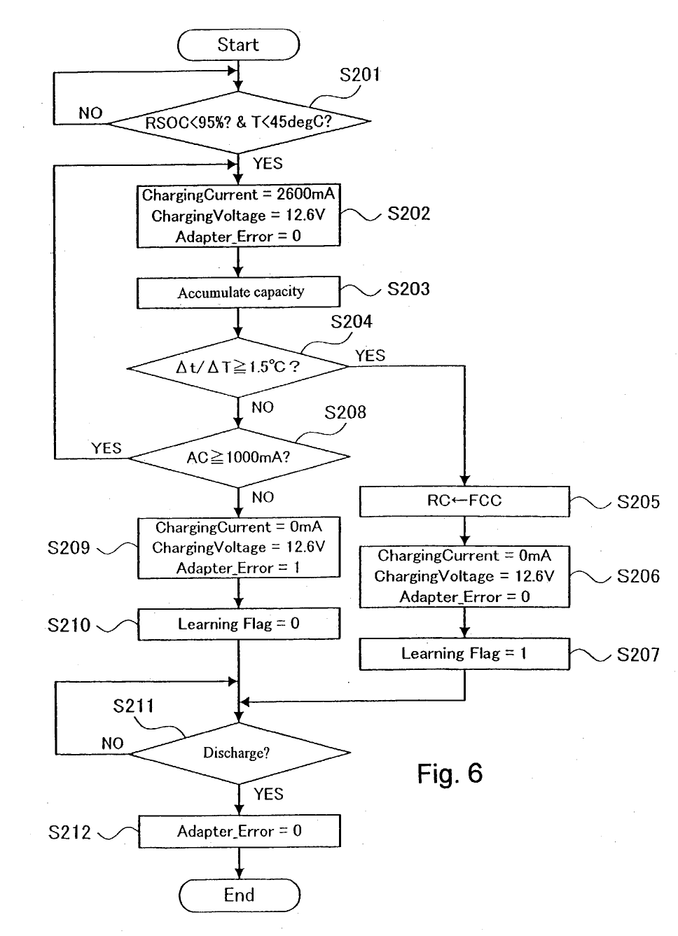

FIG. 6 is a flowchart showing a process that is performed by the CPU 62 inside the intelligent battery 52 when the nickel hydrogen battery is employed. First of all, the CPU 62 makes a judgement of whether or not the residual capacity percentage RSOC of the battery (cell 61) is smaller than 95%, and the battery temperature is lower than 45 [symbol] C. (step 201) in the same manner as when the lithium ion battery is used as shown in FIG. 4. If this condition is not satisfied, the battery can not be charged, whereby the operation returns to step 201. If this condition is satisfied, the battery can be charged, whereby ChargingCurrent ( )=2600 mA, ChargingVoltage ( )=12.6V and Adapter_Error=0 are sent to the embedded controller 41 (step 202). The capacity is accumulated (step 203), and the residual capacity data (RC) is updated.

Then, it is confirmed here whether the battery is full of charge, unlike the lithium ion battery as shown in FIG. 4. Herein, the battery is regarded as full of charge if the temperature rise per unit time is 1.5 [symbol] C. or more, whereby a check is made whether or not Dt/DT is 1.5 [symbol] C. or more (step 204). Since the nickel hydrogen battery has most charge power changed into the temperature, the capacity accumulation contains an error. Thus, full of charge is judged depending on the temperature, not the judgement with RSOC. When the battery is full of charge at step 204, the operation goes to step 205, or if not, the operation transfers to step 208. The steps 205 to 207 when the battery is full of charge are the same as steps 106 to 108 as shown in FIG. 4. That is, the value of FCC is substituted for the remaining amount data (RC) (step 205). Then, ChargingCurrent=0 mA and ChargingVoltage=12.6V are sent to stop the charging, and Adapter_Error is set at 0 because the AC adapter 51 is normal (step 206). Also, since the charging is normally ended, Learning Flag is set to 1 (step 207).

If Dt/DT is smaller than 1.5 [symbol] C. (i.e. smaller than 1.5 [symbol] C. per minute) at step 204, it is checked whether or not an average charging current (AC: Average Current) is greater than or equal to 1000 mA as a reference value to be judged that a normal temperature rise occurs (step 208). This reference value is different depending on the kind of cell 61 and the constitution of the intelligent battery 52. If the average charging current is below 1000 mA, the normal temperature rise does not occur, whereby it is not possible to detect the full of charge correctly. Thus, if the average charging current is 1000 mA or more, there is no problem, whereby the operation returns to step 202, of if it is below 1000 mA, the operation proceeds to step 209, considering that the false AC adapter 51 is connected.

That is, if the charging is continued in this state, the intelligent battery 52 is overcharged and damaged, whereby ChargingCurrent=0 mA and ChargingVoltage=12.6V are set to stop the charging. Since the AC adapter 51 is regarded as abnormal, Adapter_Error is set to 1, and data is sent to the embedded controller 41 (step 209). If the embedded controller 41 detects that 1 is set at bit 15 of the received word data, it notifies the utility program of battery that the AC adapter 51 is abnormal. The utility program guides with a message as shown in FIG. 5 displayed on the LCD 18 to the user, confirming that the AC adapter 51 is normal.

The subsequent steps are the same as the steps 110 to 112 as shown in FIG. 4. That is, since the charging is not normally ended, internal Learning_Flag is set to 0 (step 210). When this flag is 0, the full charge capacity (FCC) of battery is not updated with the total discharge amount, even though the battery is fully discharged (or almost fully discharged). After step 210, a check is made whether the battery is being discharged (step 211). If not, the check is continued, and if the discharging is detected, it is meant that the abnormal AC adapter 51 is removed from the system main unit, whereby Adapter_Error is set to 0 (step 212) and the operation is ended.

In this embodiment, when the nickel hydrogen battery is employed as the intelligent battery 52, the average charging current is detected inside the battery pack of the intelligent battery 52. If the average charging current is lower than the specified value, it is recognized that the false AC adapter 51 is connected. By stopping the charging based on this recognition, the intelligent battery 52 is prevented from being overcharged and damaged.

Though this embodiment has been described using the intelligent battery 52, the technique of this embodiment is also applicable to a so-called dumb battery without the CPU 62. When the dumb battery is employed, the embedded controller 41 measures various parameters of the dumb battery, manages the capacity of the dumb battery or the like, and judges whether or not the AC adapter 51 is normal inside the embedded controller 41.

In the drawings and specifications there has been set forth a preferred embodiment of the invention and, although specific terms are used, the description thus given uses terminology in a generic and descriptive sense only and not for purposes of limitation.

What is claimed is:

1. An electric apparatus comprising:
a main body;
a power supply for said main body which supplies electrical energy from one of an AC adapter for converting alternative current to direct current and a battery which supplies energy to said main body by discharge after being charged by power from said AC adapter;
a charge status monitor which monitors a charge status to said battery from said AC adapter; and
an adaptability judge which judges whether said AC adapter has adaptability in response to a charging status of said battery monitored by said charge status monitor.

2. The electric apparatus of claim 1, wherein said charge status monitor monitors whether or not charging current becomes a level lower than a predetermined value indicating completion of charge and whether or not voltage of a battery cell and/or accumulated capacity reaches each specified value allowing to be judged that sufficient charge level is obtained.

3. The electric apparatus of claim 1, wherein said charge status monitor monitors whether or not a temperature rise per unit time exceeds a rate which is regarded as full charge of said battery and whether or not said temperature rise is lower than an average charging current necessary to obtain an accurate temperature rise.

4. The electric apparatus of claim 1, further comprising display means for displaying a warning when said adaptability judgement means judges that said AC adapter is unmatched with said main body.

5. An electric apparatus comprising:
a main body being able to be connected to an AC adapter for converting alternative current to direct current and being supplied power from said AC adapter; and
a battery being charged by power from said AC adapter and supplying power to said main body by discharge,
wherein said battery outputs information indicating that said AC adapter does not have adaptability to said main body when charging current supplied from said AC adapter becomes a level lower than a predetermined value indicating completion of charge, and voltage of a battery cell and/or accumulated capacity does not reach each specified value allowing to be judged that sufficient charge level is obtained.

6. The electric apparatus of claim 5, wherein said battery does not update the full charge capacity of battery with the total amount of discharge when said AC adapter does not have adaptability.

7. An electric apparatus comprising:
a main body being able to be connected to an AC adapter for converting alternative current to direct current and being supplied power from said AC adapter; and
a battery being charged by power from said AC adapter and supplying power to said main body by discharge,
wherein said battery outputs information indicating that said AC adapter does not have adaptability to said main body when a temperature rise per unit time exceeds a rate which is regarded as full charge of said battery and said temperature rise is lower than an average charging current necessary to obtain an accurate temperature rise.

8. The electric apparatus of claim 7, wherein said main body stops charging said battery when said battery outputs the information indicating that said AC adapter does not have adaptability.

9. A computer comprising:
a system which can be connected to one of an AC adapter which converts alternative current to direct current to supply power and a battery which supplies power to said system by discharge after charge by power from said AC adapter,
a charge status monitor which monitors a charge status to said battery from said connected AC adapter; and
an adaptability judge which judges whether or not said AC adapter has adaptability in response to a charging status of said battery monitored by said charge status monitor means.

10. A computer comprising:
a system which can be connected to one of an AC adapter which converts alternative current to direct current to supply power and a battery which supplies power to said system by discharge after charge by power from said AC adapter;
a first judge which judges whether or not charging current supplied from said AC adapter to said battery becomes a level lower than a predetermined value indicating completion of charge;
a second judge which judges whether or not voltage of a battery cell and/or accumulated capacity of said battery reaches each specified value allowing to be judged that sufficient charge level is obtained; and
an adaptability judge which judges whether or not said AC adapter connected to said system has adaptability in response to a judgement of said first judgement means and a judgement of said second judgement means.

11. The computer of claim 10, wherein said adaptability judge judges that said AC adapter connected to said system has no adaptability to said system when said first judge judges that charging current becomes a level lower than a predetermined value and said second judge judges that voltage of said battery cell and/or said accumulated capacity does not reach each specified value.

12. The computer of claim 11, wherein said predetermined value subject to judgement of said first judge is 150 mA, and said specified value subject to judgement of said second judge is 41V for the voltage of said cell and 90% of residual capacity for said accumulated capacity.

13. A computer comprising:
a system which can be connected to one of an AC adapter which converts alternative current to direct current to supply power and a battery which supplies power to said system by discharge after charge by power from said AC adapter;
a temperature rise monitor which monitors whether or not a temperature rise per unit time exceeds a rate which is regarded as full charge of said battery;
a charging current monitor which monitors whether or not an average charging current is lower than a reference value necessary to cause an accurate temperature rise; and
an adaptability judge which judges that said AC adapter does not have adaptability when said temperature rise monitored by said temperature rise monitor means exceeds said rate and said average charging current monitored by said charging current monitor means is lower than said reference value.

14. The computer of claim 13, wherein said temperature is 1.5 [symbol] C./min, and said reference value is an average charging current of 1000 mA.

15. An intelligent battery being able to be connected to an electric apparatus and supplying power to a main body of said electric apparatus by discharge after charge by power from an AC adapter connected to said electric apparatus, said intelligent battery comprising:
a charging current monitor which monitors a charging current supplied from said AC adapter;
a voltage/capacity monitor which monitors the voltage of a cell making up said intelligent battery and/or accumulated capacity of said battery; and
an adaptability judge which judges whether or not said AC adapter connected to said main body has adaptability in response to a monitor of the charging current by said charging current monitor and a monitor of the voltage of the cell and/or accumulated capacity by said voltage/capacity monitor.

16. The intelligent battery of claim 15, wherein said charging current monitor monitors whether or not charging current becomes a level lower than a predetermined value indicating completion of charge, said voltage/capacity monitor monitors whether or not the voltage of said cell and/or said accumulated capacity reaches each specified value allowing to be judged that sufficient charge level is obtained, and said adaptability judge judges that said AC adapter connected to said main body does not have adaptability when said charging current monitor monitors that said charging current is lower than said predetermined value and said voltage/capacity monitor monitors that said voltage and/or said accumulated capacity does not reach each specified value.

17. An intelligent battery being able to be connected to an electric apparatus and supplying power to a main body of said electric apparatus by discharge after charge by power from an AC adapter connected to said electric apparatus, said intelligent battery comprising:
a temperature rise monitor which monitors a level of temperature rise;
a charging current monitor which monitors a level of charging current supplied from said AC adapter; and
an adaptability judge which judges whether or not said AC adapter connected to said main body has adaptability in response to the level of said temperature rise monitored by said temperature rise monitor and the level of said charging current monitored by said charging current monitor.

18. The intelligent battery of claim 17, wherein said temperature rise monitor monitors whether or not a temperature rise per unit time exceeds a rate which is regarded as full charge, said charging current monitor monitors whether or not an average charging current is lower than a reference value necessary to cause a normal temperature rise, and said adaptability judge judges that said AC adapter does not have adaptability when said temperature rise exceeds said rate and said average charging current is lower than said reference value.

19. Apparatus comprising:
a housing;
a plurality of rechargeable battery cells within said housing;
a processor within said housing;
a current measuring circuit within said housing and operatively coupled with said plurality of cells and said processor;
a voltage measuring circuit within said housing and operatively coupled with said plurality of cells and said processor;
a temperature monitor within said housing and operatively coupled with said plurality of cells and said processor; and
program instructions stored accessibly to said processor and effective when executing thereon to:
judge whether charging current supplied from an attached AC adapter after charging of said cells comes to a level lower than a predetermined value indicating completion of charge;
judge whether voltage of a battery cell and/or accumulated capacity of said apparatus reaches a level indicative that sufficient charge level is obtained by charge from said AC adapter; and
judge whether the attached AC adapter has adaptability in response to the judgements of the preceding judgements.

20. A method for checking an AC adapter connected to an electric apparatus which has a battery comprising the steps of:
judging whether or not charging current supplied from said AC adapter to said battery for supplying power by discharge after charge becomes a level lower than a predetermined value indicating completion of charge;
judging whether or not voltage of a battery cell and/or accumulated capacity of said battery reaches each level allowing to be judged that sufficient charge level is obtained by charge from said AC adapter; and
judging whether or not said connected AC adapter has adaptability in response to the judgements of said first and second steps.

21. A method for checking an AC adapter connected to an electric apparatus, comprising the steps of:
judging whether or not a temperature rise per unit time exceeds a rate which is regarded as full of charge for a battery for supplying power by discharge after charge;
judging whether or not an average charging current is lower than a reference value necessary to cause a normal temperature rise by charge from said AC adapter; and
judging that said connected AC adapter does not have adaptability when said temperature rise monitored at said first step exceeds said rate and said average charging current monitored at said second step is lower than said reference value.
